(19) United States
(12) Patent Application Publication
(10) Pub. No.: US 2010/0258255 A1
(43) Pub. Date: Oct. 14, 2010

(54) Shutter type roll screen

(75) Inventor: Kye-Won Lee, Seoul (KR)

Correspondence Address: GWIPS;Peter T. Kwon, Gwacheon P.O. Box 72, 119 Byeolyang Ro, Gwacheon City, Gyeonggi-Do, 427-600, KR

(73) Assignee: KOIN C&M Co., Ltd

(21) Appl. No.: 12/385,466

(22) Filed: Apr. 9, 2009

(51) Int. Cl. E06B 9/56

(52) U.S. Cl. 160/319

(57) ABSTRACT

A new concept of roll screen is provided to provide transparent portions, which are spaced apart at regular intervals. The screen is unrolled into double-layer to adjust the amount of light interpenetrated to the room. The roll screen includes a mounting frame fastened to a wall or ceiling of a building, and a drive cap provided on a first end of the mounting frame. The drive cap has a ball chain, which rotates a winding roll around first end of the wound screen. The roll screen further includes a driven cap provided on a second end of the mounting frame, and a screen holding frame, which is holding a second end of the screen and removable to the front or rear surface of the mounting frame. The screen is easily installed onto or separated from the mounting frame without separating the winding roll from the mounting frame.

### BACKGROUND OF THE INVENTION

1. Field of the Invention

The present invention relates to a roll screen and, more particularly, the roll screen is able to adjust the amount of light interpenetrated into the room. The roll screen can be easily coupled to or separated from a mounting frame fastened to a wall or ceiling of a building.

2. Related Prior Art

Generally, the blind apparatuses are installed around windows to block light, to adjust the amount of light entering rooms such that the indoor atmosphere can be changed, to prevent an increase of indoor temperature attributable to direct rays of sunlight in a hot season, such as the summer, or to block the view of the room from the outside such that the private life of users can be preserved.

Such blind apparatuses are classified into various kinds including a Venetian blind, a roll screen, a roll fabric, etc. according to a shape, function or operating method.

From among the blind apparatuses, a roll screen is a kind of blind apparatus which has recently gained in popularity. As shown in FIG. 1, the roll screen includes a mounting frame 1 which is fastened to a wall or ceiling of a building, and a winding roll 2, around which a screen 3 is wound, and which is supported by a drive cap and a driven cap which are mounted to both ends of the mounting frame 1. The screen 3 is unrolled from or wound around the winding roll 2 by rotating the drive cap. The roll screen further includes a weight rod 4 which maintains the screen 3 tense when the screen 3 is unrolled.

Furthermore, a screen coupling part 1a is integrally provided at a predetermined position on the mounting frame 1. A first end of the screen 3 is connected to the winding roll 2, and a second end thereof is connected to the screen coupling part 1a.

However, in the conventional art, the screen coupling part is integrally provided on the mounting frame. Hence, when installing the screen on the mounting frame or separating it therefrom, the winding roll must be separated from the mounting frame.

### SUMMARY OF THE INVENTION

Accordingly, the present invention has been made keeping in mind the above problems occurring in the prior art, and an object of the present invention is to provide a roll screen in which a screen coupling part to which one end of a screen is connected is removable coupled to a mounting frame fastened to a wall or ceiling of a building, so that the screen can be easily installed on or separated from the mounting frame even without separating a winding roll holding the other end of the screen from the mounting frame.

In order to accomplish the above object, the present invention provides a roll screen, including: a mounting frame fastened to a wall or ceiling of a building; a drive cap provided on a first end of the mounting frame, the drive cap having a ball chain to rotate a winding roll, around which a first end of a screen is wound; and a driven cap provided on a second end of the mounting frame, wherein a second end of the screen is connected to the mounting frame such that the screen is unrolled into a double-layered shape. The mounting frame has a coupling part on a front or rear surface thereof, and a screen holding frame is removable coupled to the coupling part. The coupling part includes: a horizontal coupling surface extending from the front or rear surface of the mounting frame in a horizontal direction; and a vertical coupling surface extending upwards from an edge of the horizontal coupling surface in a vertical direction. The screen holding frame includes: an insert part inserted at a first edge thereof into the coupling part; a contact support part extending downwards from a second edge of the insert part in a vertical direction; a seating part extending from a lower edge of the contact support part in a horizontal direction; a vertical part extending upwards from an edge of the seating part in a vertical direction, the vertical part being parallel with the contact support part; an inclined part bent at a predetermined angle from an upper edge of the vertical part towards an upper edge of the contact support part, with an insert slot defined between the contact support part and the inclined part, so that a planar member holding a second end of the screen is inserted into the screen holding frame through the insert slot and is seated onto the seating part.

Preferably, an upper edge of the vertical coupling surface may be thicker than other portions thereof and the first edge of the insert part may be thicker than other portions thereof, so that the insert part is inserted into the coupling part by a force-fitting method.

Furthermore, the mounting frame may have a mounting part on an upper end of a front or rear surface thereof, and a screen holding frame may be connected to the mounting part. The screen holding frame may be fastened to the mounting frame by an elastic clip. The screen holding frame may include: a holding part coupled to the mounting part of the mounting frame; a contact support part vertically extending downwards from the edge of the holding part, the contact support part being compressed towards the mounting frame by the elastic clip; seating parts respectively extending from the upper portion and the lower edge of the contact support part in the horizontal direction; and locking parts respectively extending from the edges of the seating parts in the vertical directions, such that the edges of the locking parts are spaced apart from each other by a predetermined distance to form an insert slot, so that the planar member holding the second end of the screen is disposed between the seating parts.

### BRIEF DESCRIPTION OF THE DRAWINGS

FIG. 1 is a sectional view of a roll screen according to a conventional art.

FIG. 2 is a perspective view illustrating a roll screen, according to a first embodiment of the present invention.

FIG. 3 is a sectional view illustrating the roll screen of FIG. 2.

FIG. 4 is a perspective view illustrating a mounting frame and a screen holding frame of the roll screen of FIG. 2.

FIG. 5 is a section view of the mounting frame and the screen holding frame of FIG. 4.

FIG. 6 is a perspective view illustrating a roll screen, according to a second embodiment of the present invention.

FIG. 7 is a sectional view illustrating the roll screen of FIG. 6.

FIG. 8 is a perspective view illustrating a mounting frame and a screen holding frame of the roll screen of FIG. 6.

FIG. 9 is a section view of the mounting frame and the screen holding frame of FIG. 8.

FIG. 10 is a perspective view illustrating a roll screen, according to a third embodiment of the present invention.

FIG. 11 is a sectional view illustrating the roll screen of FIG. 10.

FIG. 12 is a perspective view illustrating a mounting frame and a screen holding frame of the roll screen of FIG. 10.

FIG. 13 is a section view of the mounting frame and screen holding frame of FIG. 12.

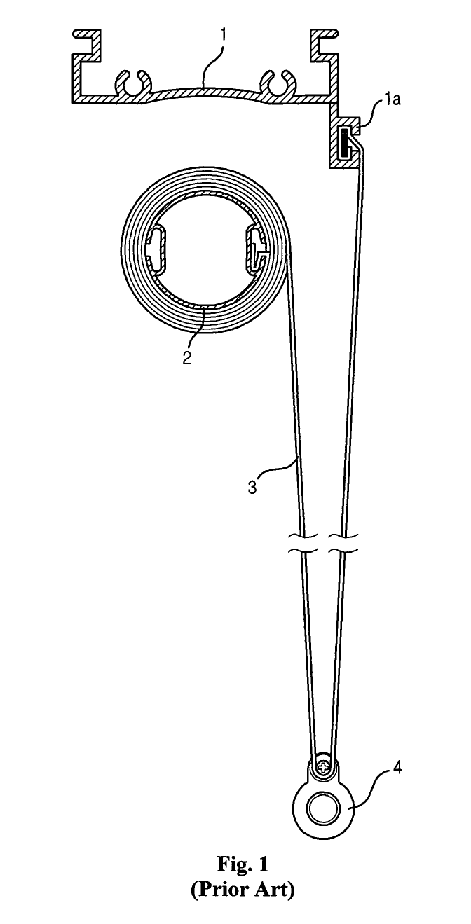

### DESCRIPTION OF THE PREFERRED EMBODIMENTS

Hereinafter, preferred embodiments of a roll screen according to the present invention will be described in detail with reference to the attached drawings.

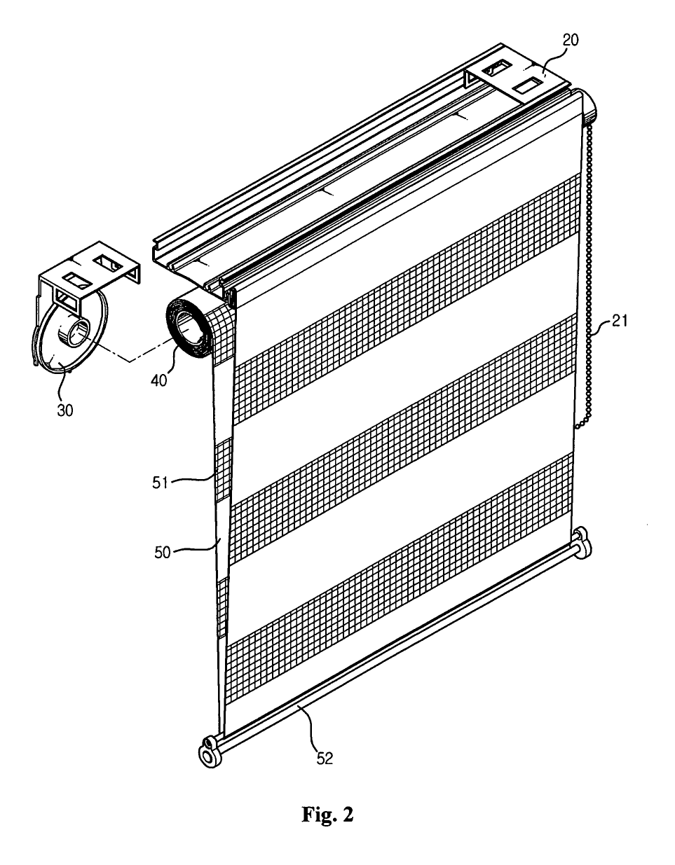

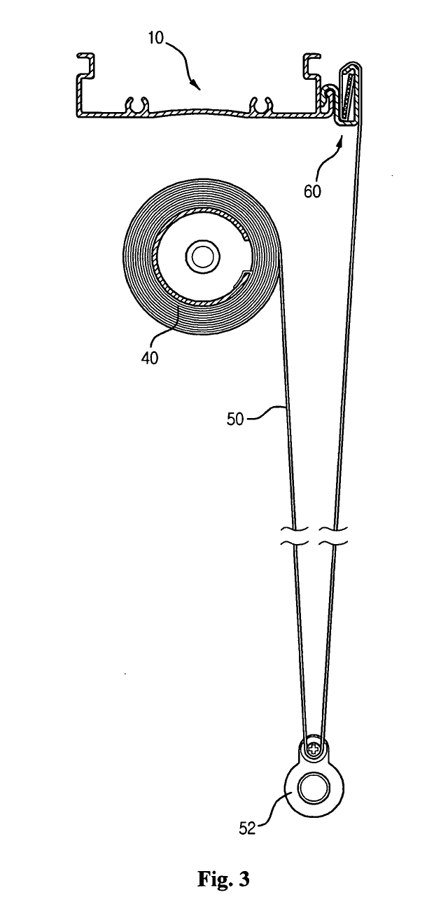

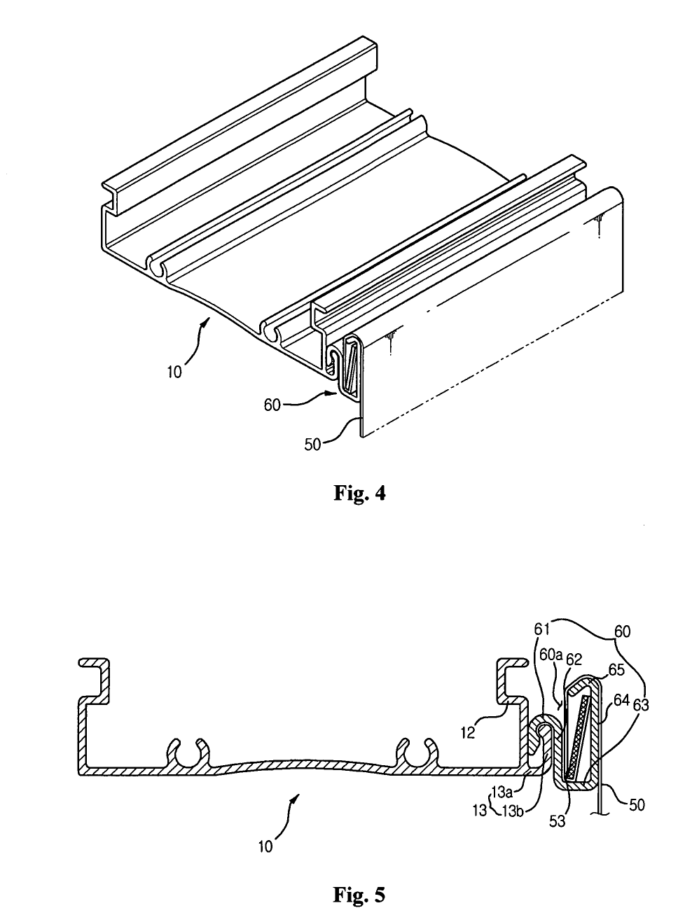

FIG. 2 is a perspective view illustrating a roll screen, according to a first embodiment of the present invention. FIG. 3 is a sectional view illustrating the roll screen of FIG. 2. FIG. 4 is a perspective view illustrating a mounting frame 10 and a screen holding frame 60 of the roll screen of FIG. 2. FIG. 5 is a sectional view of the mounting frame 10 and the screen holding frame 60 of FIG. 4.

Referring to FIGS. 2 through 5, the roll screen according to the first embodiment of the present invention includes the mounting frame 10 which is fastened to a wall or ceiling of a building, and a drive cap 20 and a driven cap 30 which are respectively provided on both ends of the mounting frame 10. The roll screen further includes a winding roll 40 which is supported between the drive cap 20 and the driven cap 30, a screen 50 which is wound at a first end thereof around the winding roll 40, and the screen holding frame 60 which holds a second end of the screen 50 and is mounted to the mounting frame 10 so that the screen 50 is unrolled into a double-layered shape.

The mounting frame 10 includes a mounting part 12 which has a depression shape and is formed in the upper end of the front or rear surface of the mounting frame 10, and a coupling part 13 which is formed in the lower end of the front or rear surface of the mounting frame 10 so that the screen holding frame 60 is removable coupled to the coupling part 13.

The coupling part 13 is integrally formed with the mounting frame 10 and includes a horizontal coupling surface 13a which extends from the front or rear surface of the mounting frame 10 in the horizontal direction, and a vertical coupling surface 13b which is integrated with the horizontal coupling surface 13a and extends upwards from the edge of the horizontal coupling surface 13a in the vertical direction.

As seen by the cross-section, the edge of the vertical coupling surface 13b has a thickness greater than that of other portions thereof.

The drive cap 20 includes a ball chain 21 which rotates the winding roll 40 around which the first end of the screen 50 is wound.

The winding roll 40 is held at both ends thereof between the drive cap 20 and the driven cap 30. Thus, the winding roll 40 is reversibly rotated in one direction depending on the direction in which a user manipulates the ball chain 21 of the drive cap 20.

The screen 50 has transparent portions 51 which are formed at positions spaced apart from each other at regular intervals. Depending on the rotation of the winding roll 40, the screen 50 is moved in one direction or in a reverse direction to adjust the amount of light entering a room.

Furthermore, a weight rod 52 is hung by the screen 50 to maintain the screen 50 tense when the screen 50 is unrolled.

The screen holding frame 60 includes an insert part 61, a contact support part 62, a seating part 63, a vertical part 64 and an inclined part 65.

The insert part 61 generally has an approximately semicircular cross-section. A first edge of the insert part 61 is fitted into the coupling part 13 that is, into a space defined by the horizontal coupling surface 13a and the vertical coupling surface 13b. As seen in the cross-section, the first edge of the insert part 61 also has a thickness greater than that of other portions thereof, in the same manner as that of the vertical coupling surface 13b. Thereby, the insert part 61 of the screen holding frame 60 is coupled to the coupling part 13 by a force-fitting method. In detail, a distance between the edge of the vertical coupling surface 13b of the coupling part 13 and the front or rear surface of the mounting frame 10 is less than the thickness of the first edge of the insert part 61. Therefore, to fit the insert part 61 into the coupling part 13, a worker must apply external force to them such that the vertical coupling surface 13b of the coupling part 13 is elastically moved away from the front or rear surface of the mounting frame 10 due to the thickness of the first edge of the insert part 61 and then the insert part 61 is inserted into the coupling part 13.

The contact support part 62 extends downwards from a second edge of the insert part 61 and comes into surface contact with the outer surface of the vertical coupling surface 13b of the coupling part 13 when the screen holding frame 60 is mounted to the mounting frame 10.

The seating part 63 extends from the edge of the contact support part 62 in the horizontal direction. A planar member 53 which will be explained later is seated on the seating part 63.

The vertical part 64 extends upright from the edge of the seating part 63 such that it is parallel with the contact support part 62. Here, the vertical part 64 is higher than the contact support part 62.

The inclined part 65 is bent at a predetermined angle from the edge of the vertical part 64 towards the upper edge of the contact support part 62. Here, the edge of the inclined part 65 is not connected to the upper edge of the contact support part 62, in other words, it is spaced apart from the upper edge of the contact support part 62 by a predetermined distance, so that an insert slot 60a is defined between the inclined part 65 and the contact support part 62.

The insert slot 60a functions as a passage through which the planar member 53 fastened to the second end of the screen 50 is inserted into the screen holding frame 60. The planar member 53 that passes through the insert slot 60a is seated onto the upper surface of the seating part 63. Preferably, the planar member 53 has a height greater than the width of the insert slot 60a to prevent the planar member 53 from being removed from the screen holding frame 60 when the screen 50 is moved by manipulating the ball chain 21.

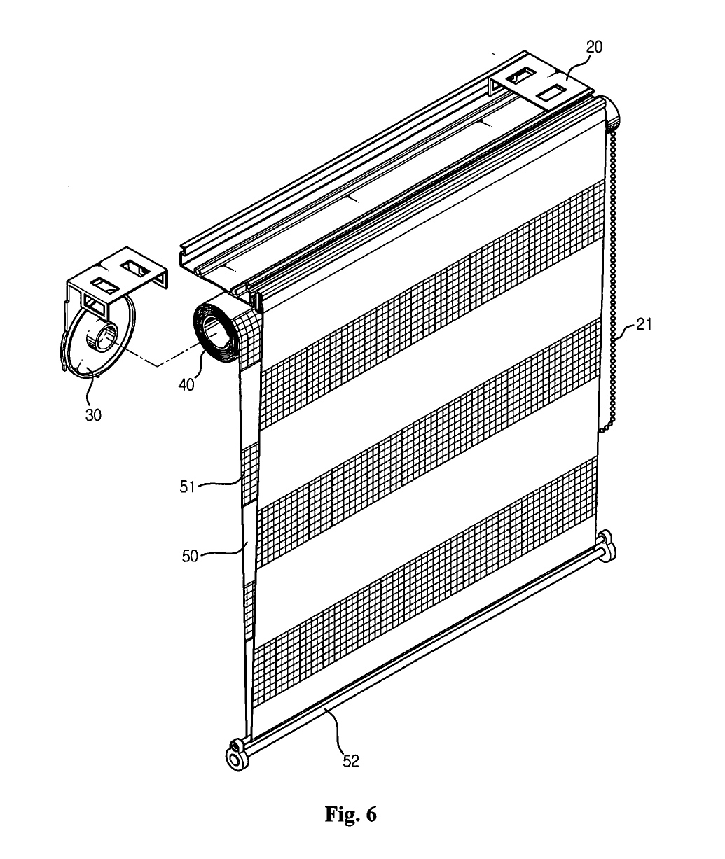

Meanwhile, the roll screen according to the present invention is not limited to the embodiment shown in FIGS. 2 through 5 and may have the construction shown in FIGS. 6 through 9.

The general construction of the roll screen shown in FIGS. 6 through 9 is almost the same as that of the roll screen shown in FIGS. 2 through 5, and they are only partially different from each other, therefore the roll screen of FIGS. 6 through 9 will be explained, focusing on the differences between it and the roll screen of FIGS. 2 through 5. Furthermore, in the following description, reference should be made to the drawings, in which the same reference numerals are used throughout the different drawings to designate the same components.

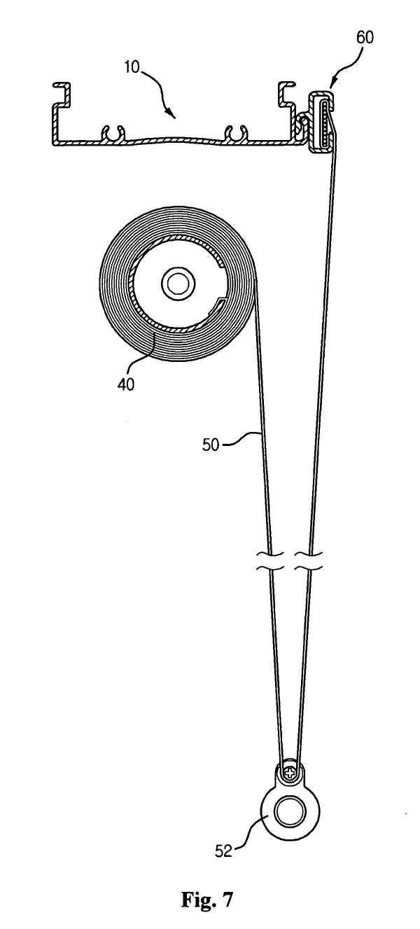

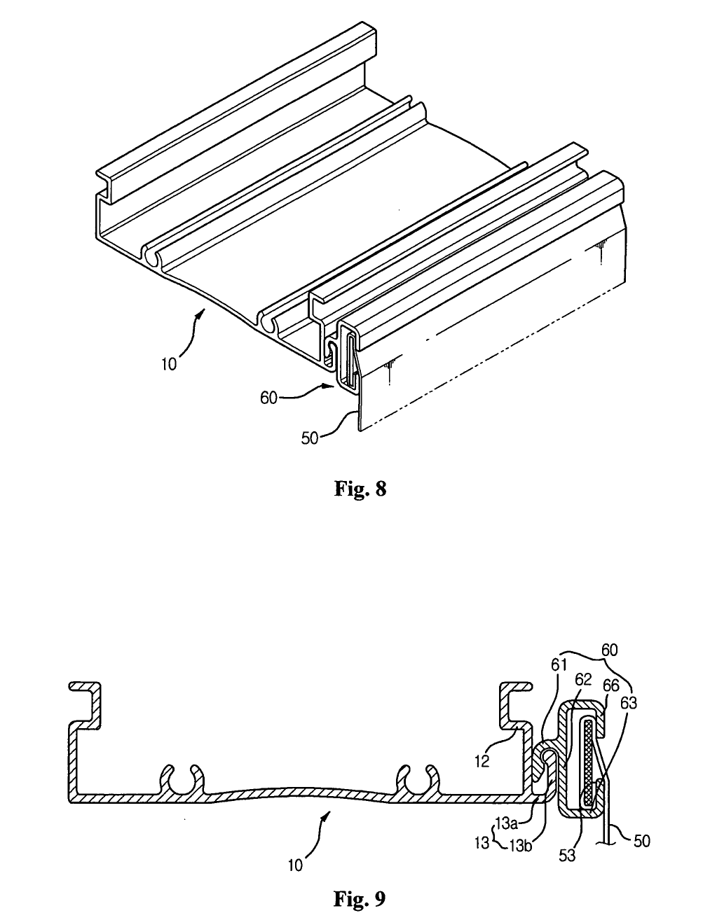

FIG. 6 is a perspective view illustrating a roll screen, according to a second embodiment of the present invention. FIG. 7 is a sectional view illustrating the roll screen of FIG. 6. FIG. 8 is a perspective view illustrating a mounting frame 10 and a screen holding frame 60 of the roll screen of FIG. 6. FIG. 9 is a sectional view of the mounting frame 10 and the screen holding frame 60 of FIG. 8.

As shown in FIGS. 6 through 9, in the roll screen according to the second embodiment, the screen holding frame 60 includes an insert part 61, a contact support part 62, seating parts 63 and locking parts 66.

The insert part 61 has a rounded ‘L’ shape and is fitted into the coupling part 13 of the mounting frame 10. A first edge of the insert part 61 is thicker than other portions thereof, in the same manner as that of the coupling part 13 of FIGS. 2 through 5.

The contact support part 62 vertically extends upwards and downwards from a second edge of the insert part 61. A portion of the contact support part 62 which is disposed below the second edge of the insert part 61 is in surface contact with the vertical coupling surface 13b of the coupling part 13.

The seating parts 63 respectively extend from upper and lower edges of the contact support part 62 in the horizontal direction. A planar member 53 is disposed between the seating parts 63.

The locking parts 66 respectively extend from the edges of the seating parts 63 in the vertical direction, such that the edges of the locking parts 66 are spaced apart from each other by a predetermined distance to form an insert slot 60a. The planar member 53 which is fastened to the second end of the screen 50 is inserted into the screen holding frame 60 through the insert slot 60a.

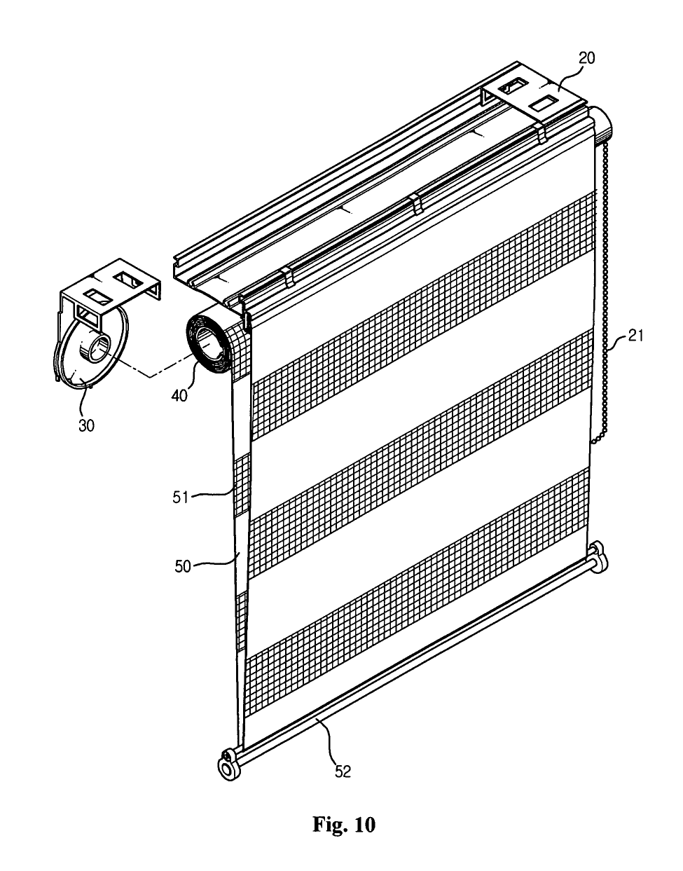

Meanwhile, the roll screen according to the present invention may have the construction shown in FIGS. 10 through 13.

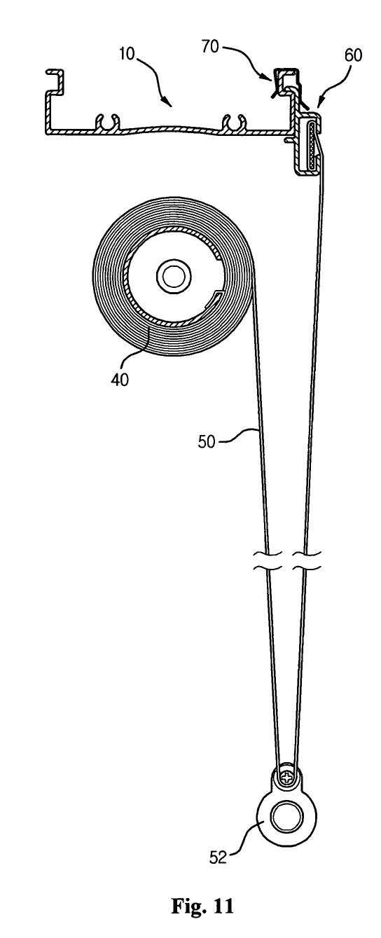

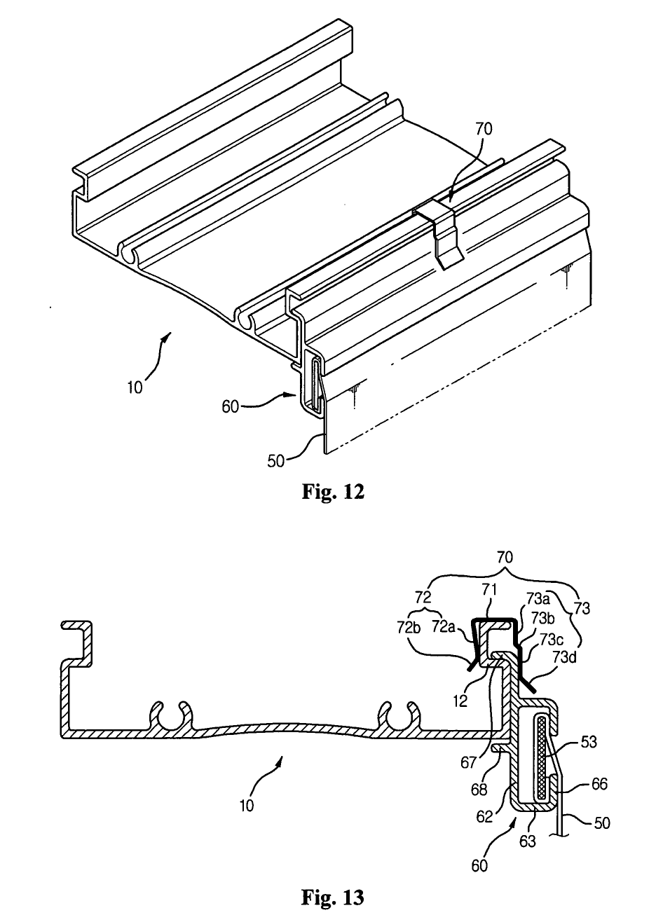

FIG. 10 is a perspective view illustrating a roll screen, according to a third embodiment of the present invention. FIG. 11 is a sectional view illustrating the roll screen of FIG. 10. FIG. 12 is a perspective view illustrating a mounting frame 10 and a screen holding frame 60 of the roll screen of FIG. 10. FIG. 13 is a sectional view of the mounting frame 10 and the screen holding frame 60 of FIG. 12.

As shown in FIGS. 10 through 13, in the roll screen according to the third embodiment, the mounting frame 10 is not provided with a coupling part 13, so that the screen holding frame 60 is coupled to a mounting part 12 formed in the upper end of the front or rear surface of the mounting frame 10, unlike the prior embodiments in which the coupling part 13 is formed in the lower end of the front or rear surface of the mounting frame 10. Here, the screen holding frame 60 is fastened to the mounting frame 10 by an elastic clip 70.

Furthermore, the screen holding frame 60 of FIGS. 10 through 13 includes a holding part 67, a contact support part 62, seating parts 63 and locking parts 66.

The holding part 67 is coupled to the mounting part 12 of the mounting frame 10. The contact support part 62 vertically extends downwards from the edge of the holding part 67. In addition, the contact support part 62 is compressed towards the mounting frame 10 by the elastic clip 70. Thereby, the surface of the contact support part 62 is brought into surface to contact with the outer surface of the lower portion of the mounting part 12.

The seating parts 63 respectively extend from the upper portion and the lower edge of the contact support part 62 in the horizontal direction. A planar member 53 is disposed between the seating parts 63.

The locking parts 66 respectively extend from the edges of the seating parts 63 in the vertical directions, such that the edges of the locking parts 66 are spaced apart from each other by a predetermined distance to form an insert slot 60a. The planar member 53 which is fastened to the second end of the screen 50 is inserted into the screen holding frame 60 through the insert slot 60a.

Furthermore, a rib 68 horizontally protrudes from a central portion of the contact support part 62 in the direction opposite the seating parts 63. The rib 68 is brought into contact with the lower surface of the mounting frame 10 when the screen holding frame 60 is biased to rotate around the contact point with the elastic clip 70 due to rotational moment, thus restraining the rotational moment of the screen holding frame 60.

The elastic clip 70 includes an elastic horizontal surface 71, a first elastic inclined surface 72 and a second elastic inclined surface 73. The elastic horizontal surface 71 is brought into close contact with the upper surface of the mounting frame 10. The first elastic inclined surface 72 is bent at a predetermined angle from a first edge of the elastic horizontal surface 71 towards the mounting frame 10 and compresses the mounting frame 10 using the elastic force thereof. The second elastic inclined surface 73 is bent at a predetermined angle from a second edge of the elastic horizontal surface 71 towards the contact support part 62 of the screen holding frame 60 and compresses the contact support part 62 using the elastic force thereof. Here, the second elastic inclined surface 73 is longer than the first elastic inclined surface 72.

The first elastic inclined surface 72 includes a first main inclined surface 72a which is bent at a predetermined angle from the first edge of the elastic horizontal surface 71 towards the mounting frame 10, and a first auxiliary inclined surface 72b which is bent from the edge of the first main inclined surface 72a in a direction opposite the direction in which the first main inclined surface 72a is bent. The first auxiliary inclined surface 72b facilitates the opening of the elastic clip 70.

The second elastic inclined surface 73 includes a second main inclined surface 73a which is bent at a predetermined angle from the second edge of the elastic horizontal surface 71 towards the contact support part 62 of the screen holding frame 60, and an intermediate inclined surface 73b which is bent from the edge of the second main inclined surface 73a in a direction opposite the direction in which the second main inclined surface 73a is bent. The second elastic inclined surface 73 further includes a compression inclined surface 73c which is connected to the edge of the intermediate inclined surface 73b and is bent towards the contact support part 62 of the screen holding frame 60 to compress the contact support part 62, and a second auxiliary inclined surface 73d which is bent from the edge of the compression inclined surface 73c towards the locking parts 66 of the screen holding frame 60 to facilitate the opening of the elastic clip 70.

The first auxiliary inclined surface 72b and the second auxiliary inclined surface 73d prevent the edges of the elastic clip 70 from being snagged by the mounting frame 10 or the screen holding frame 60 when pushing the elastic clip 70 downwards to fit it over the mounting frame 10, thus facilitating the opening of the elastic clip 70, thereby making the installation of the elastic clip 70 easy.

As described above, in a roll screen according to the present invention, a screen holding frame which holds one end of a screen is removable fastened to a mounting frame, so that the screen can be easily assembled with or disassembled from the mounting frame even without separating a winding roll from the mounting frame.

Furthermore, in the case of the use of an elastic clip, the existing screen holding frame can also be easily fastened to the mounting frame.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A roll screen, comprising:
a mounting frame fastened to a wall or ceiling of a building; a drive cap provided on a first end of the mounting frame, the drive cap having a ball chain to rotate a winding roll, around which a first end of a screen is wound; and a driven cap provided on a second end of the mounting frame, wherein a second end of the screen is connected to the mounting frame such that the screen is unrolled into a double-layered shape, wherein the mounting frame has a coupling part on a front or rear surface thereof, and a screen holding frame is removable coupled to the coupling part,
the coupling part comprises: a horizontal coupling surface extending from the front or rear surface of the mounting frame in a horizontal direction; and a vertical coupling surface extending upwards from an edge of the horizontal coupling surface in a vertical direction,
the screen holding frame comprises: an insert part inserted at a first edge thereof into the coupling part; a contact support part extending downwards from a second edge of the insert part in a vertical direction; a seating part extending from a lower edge of the contact support part in a horizontal direction; a vertical part extending upwards from an edge of the seating part in a vertical direction, the vertical part being parallel with the contact support part; an inclined part bent at a predetermined angle from an upper edge of the vertical part towards an upper edge of the contact support part, with an insert slot defined between the contact support part and the inclined part, so that a planar member holding a second end of the screen is inserted into the screen holding frame through the insert slot and is seated onto seating part.

2. The roll screen as set forth in claim 1, wherein an upper edge of the vertical coupling surface is thicker than other portions thereof and the first edge of the insert part is thicker than other portions thereof, so that the insert part is inserted into the coupling part by a force-fitting method.

3. A roll screen, comprising:
a mounting frame fastened to a wall or ceiling of a building; a drive cap provided on a first end of the mounting frame, the drive cap having a ball chain to rotate a winding roll, around which a first end of a screen is wound; and a driven cap provided on a second end of the mounting frame, wherein a second end of the screen is connected to the mounting frame such that the screen is unrolled into a double-layered shape, wherein the mounting frame has a coupling part on a front or rear surface thereof, and a screen holding frame is removable coupled to the coupling part,
the coupling part comprises: a horizontal coupling surface extending from the front or rear surface of the mounting frame in a horizontal direction; and a vertical coupling surface extending upwards from an edge of the horizontal coupling surface in a vertical direction, and
the screen holding frame comprises: an insert part inserted at a first edge thereof into the coupling part; a contact support part extending upwards and downwards from a second edge of the insert part in vertical directions; seating parts respectively extending upper and lower edges of the contact support part in horizontal directions; and locking parts respectively extending from edges of the seating parts in vertical directions, such that facing edges of the locking parts are spaced apart from each other by a predetermined distance to form an insert slot there between, so that a planar member holding a second end of the screen is inserted into the screen holding frame through the insert slot and is seated onto the seating part.

4. The roll screen as set forth in claim 3, wherein an upper edge of the vertical coupling surface is thicker than other portions thereof and the first edge of the insert part is thicker than other portions thereof, so that the insert part is inserted into the coupling part by a force-fitting method.

5. A roll screen, comprising: a mounting frame fastened to a wall or ceiling of a building; a drive cap provided on a first end of the mounting frame, the drive cap having a ball chain to rotate a winding roll, around which a first end of a screen is wound; and a driven cap provided on a second end of the mounting frame, wherein a second end of the screen is connected to the mounting frame such that the screen is unrolled into a double-layered shape, wherein the mounting frame has a mounting part on an upper end of a front or rear surface thereof, and a screen holding frame is connected to the mounting part, and the screen holding frame is fastened to the mounting frame by an elastic clip.
